(19) United States
(12) Patent Application Publication
(10) Pub. No.: US 2006/0246933 A1
(43) Pub. Date: Nov. 2, 2006

(54) Method and system for setting up a call in a mobile communication system supporting PTT service

(75) Inventors: Ho-Taek Na, Yongin-si (KR); Kyu-Yeon Kim, Hwaseong-si (KR); Bo-Young Yoon, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/407,072

(22) Filed: Apr. 20, 2006

(30) Foreign Application Priority Data
Apr. 20, 2005 (KR) 2005-32791

(51) Int. Cl. H04B 7/00; H04Q 7/20

(52) U.S. Cl. 455/518

(57) ABSTRACT

A method and system for providing a Push-To-Talk (PTT) service in association with a Radio Access Network (RAN) and an Internet Protocol (IP) network are provided. Each of access terminals (ATs) supporting the PTT service is allocated a multicast IP during session setup, and joins in a chat room for a group for the PTT service using a multicast protocol message. Each of access networks (ANs) allocates a shared channel to the RAN to process a group call between ATs in the group if the AT is an AT in the group. A PTT system performs session setup with the AT, allocates information including a multicast IP allocated to the group of the AT during the session setup, and after the session setup, provides the PTT service between the ATs in the group using a routing protocol for the multicast IP in the IP network. Each router configures a multicast tree of the group, and upon receiving transmission data from the AT, transmits the data to the ATs in the group according to the multicast tree.

### CROSS-REFERENCE TO RELATED APPLICATIONS

This application claims the benefit under 35 U.S.C. § 119(a) of Korean Patent Application Serial No. 2005-32791, filed Apr. 20, 2005 in the Korean Intellectual Property Office, the entire disclosure of which is hereby incorporated by reference.

### BACKGROUND OF THE INVENTION

1. Field of the Invention

The present invention relates generally to a method and system for processing data in a mobile communication system. More particularly, the present invention relates to a method and system for setting up a call in a mobile communication system supporting Push-To-Talk (PTT) service.

2. Description of the Related Art

Mobile communication systems were developed to allow users to enjoy a call without restriction by physical lines. Therefore, users of such mobile communication systems can enjoy calls at anyplace and at anytime, by carrying their own terminals. With the rapid development of communication technologies and users' demands for high-quality services, mobile communication systems can now support data communication as well as the conventional voice communication. A brief description will now be made of certain types of data communications supported by mobile communication systems.

Short Message Service (SMS) is the simplest type of the data communication. The SMS service delivers SMS messages, input by a user, to a called terminal through a messaging system. Another type of data communication supported by mobile communication systems is high-speed multimedia service. High-speed multimedia service has achieved advanced technical development. As a result, the 3rd Generation Partnership Project 2 (3GPP2), the standardization group for synchronous communication systems, has reached the final standardization phase for the 1x EV-DO system and the 1x EV-DV system. Currently, many countries have reached the phase of providing commercial services using the 1x EV-DO system.

Of the mobile communication systems, the 1x EV-DO system, which is a system for processing only high-speed data, cannot provide basic voice service because the high-speed data is provided in packet form. Accordingly, there is a need for a scheme which is capable of providing voice service using the packet form, not only in the 1x EV-DO system but also in other systems providing high-speed data service. In order to meet the need, there is active research on a scheme for providing voice service in mobile communication systems which are capable of providing packet data service. For example, the Voice-over-Internet Protocol (VoIP) service and the PTT service provide voice service to users using packet data.

Currently, the PTT service is basically provided using a 1:N communication scheme, while the VoIP service is generally provided using a 1:1 communication scheme. However, even the PTT service can be provided using the 1:1 communication scheme. Generally, in the PTT service, communication is performed between users in a particular group, and if one user acquiring the floor (or the right to speak) transmits a voice message, the other users receive the voice message one-sidedly. The PTT service, unlike the cellular communication service, can simultaneously and rapidly deliver voice messages to a plurality of users, so it is expected to be actively used in the future.

With reference to FIG. 1, a brief description will now be made of a system for providing the PTT service.

FIG. 1 is a diagram illustrating the architecture of a mobile communication system in which a Radio Access Network (RAN) 103 provides PTT service. The RAN 103 can be a CDMA2000 1x or CDMA2000 1x EV-DO mobile communication network. For convenience, it will be assumed herein that the RAN 103 is a CDMA2000 1x EV-DO network.

Referring to FIG. 1, the mobile communication system includes an Access Terminal (AT) 101 supporting CDMA2000 1x EV-DO service and PTT service, the RAN 103 for exchanging packets with the AT 101 over a radio channel, a Packet Data Service Node (PDSN) 105 for connecting the RAN 103 to a packet communication network 107 using the Internet Protocol (IP), and a PTT server 109 connected to the PDSN 105, for managing the PTT session and relaying voice packets from a calling user to a called user group.

A description will now be made of a group call method in this PTT service network. If a calling user pushes a PTT button on his or her AT 101 to make a PTT group call, the PTT AT 101 transmits a PTT Request message with a Group Identifier (ID) to the PTT server 109. At this point, the RAN 103 allocates a traffic channel for the calling user, and upon receiving the PTT Request message, the PTT server 109 searches a group list management server for group members of the requested Group ID. Thereafter, the PTT server 109 allocates traffic channels in the RAN 103 to the called users in the group. If the called user responds to the PTT Request message, the PTT server 109 gives the floor to the calling user. If the calling user, after obtaining the floor, starts speaking, voice packet data is transmitted to all subscribers via the PTT server 109.

In this group call method, for the subscribers in each group, call setup is achieved using a unicast scheme. However, the RAN 103 has a limitation in the number of allocable traffic channels per sector. Therefore, if many subscribers simultaneously exchange PTT Request messages and PTT Response messages with the PTT server 109, the call setup time increases due to collision between air signals. For example, if 50 subscribers have gathered in one CDMA RAN sector, the group call setup time may exceed 40 seconds due to the air signal collisions. This may impede the rapid characteristic of the PTT service, and cause a reduction in the number of subscribers able to use the system due to the resource limitation in the RAN 103. These problems may lead to a group call model which is inappropriate for the PTT service since the PTT service should have a short call setup time.

Accordingly, there is a need for an improved method and system for setting up a call in a mobile communication system supporting PTT service.

### SUMMARY OF THE INVENTION

Exemplary embodiments of the present invention address at least the above problems and/or disadvantages and provide at least the advantages described below. Accordingly, an exemplary aspect of the present invention to provide a call setup method and system capable of accommodating many subscribers in a mobile communication system supporting PTT service.

It is another exemplary aspect of the present invention to provide a call setup method and system capable of reducing a call setup time in a mobile communication system supporting PTT service.

It is further another exemplary aspect of the present invention to provide a call setup method and system for guaranteeing high security for inter-group communication in a mobile communication system supporting PTT service.

It is yet anther exemplary aspect of the present invention to provide a group call method capable of efficiently using resources in a mobile communication system supporting PTT service.

According to one exemplary aspect of the present invention, there is provided a system for providing a Push-To-Talk (PTT) service in association with a Radio Access Network (RAN) and an Internet Protocol (IP) network. The system comprises a plurality of access terminals (ATs), supporting the PTT service, for receiving a multicast IP allocated thereto during session setup, and joining in a chat room for a group for the PTT service using a multicast protocol message; a plurality of access networks (ANs) for allocating a shared channel to the RAN to process a group call between ATs in the group if the AT is an AT in the group; a plurality of PTT systems for performing session setup with the AT, allocating information including a multicast IP allocated to the group of the AT during the session setup, and after the session setup, providing the PTT service between the ATs in the group using a routing protocol for the multicast IP in the IP network; and a plurality of routers for configuring a multicast tree of the group, and upon receiving transmission data from the AT, transmitting the data to the ATs in the group according to the multicast tree.

The PTT system comprises a PTT server for managing a session of the ATs in the group, and upon receiving data transmitted by a calling AT in the group, transmitting the data to the routers to provide a group call between the ATs in the group; and a group list management server (GLMS) for managing a multicast IP pool and a security session key allocated to the group.

The routing protocol is a Core Based Multicast protocol, and the Core Based Multicast protocol is an Internet Group Management Protocol (IGMP).

### BRIEF DESCRIPTION OF THE DRAWINGS

The above and other objects, features and advantages of exemplary embodiments of the present invention will become more apparent from the following detailed description when taken in conjunction with the accompanying drawings in which:

FIG. 1 is a diagram illustrating a general mobile communication system supporting PTT service;

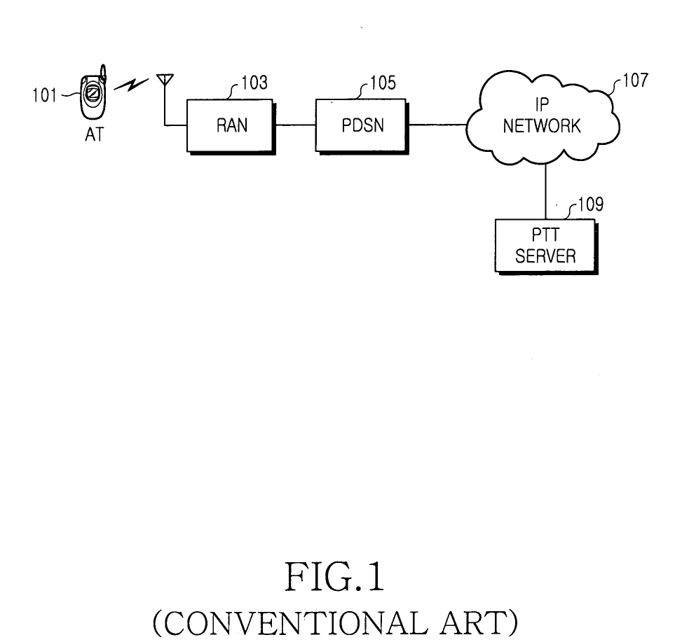

FIG. 2 is a diagram illustrating architecture of a mobile communication system supporting PTT service according to an exemplary embodiment of the present invention;

FIG. 3 is a flowchart illustrating a process of joining in a chat room by an AT in a group in a mobile communication system supporting PTT service according to an exemplary embodiment of the present invention;

FIG. 4 is a flowchart illustrating a chat room joining method according to an exemplary embodiment of the present invention; and

FIG. 5 is a flowchart illustrating a process of setting up a group call in the state where ATs in a group are set in a chat room according to an exemplary embodiment of the present invention.

### DETAILED DESCRIPTION OF EXEMPLARY EMBODIMENTS

Exemplary embodiments of the present invention will now be described in detail with reference to the annexed drawings. In the drawings, the same or similar elements are denoted by the same reference numerals even though they are depicted in different drawings. In the following description, a detailed description of known functions and configurations incorporated herein has been omitted for clarity and conciseness.

The exemplary embodiments of the present invention propose a call setup method and system that uses a multicast IP to guarantee fast call setup time among a group and increase resource efficiency in a mobile communication system supporting PTT service. In addition, the exemplary embodiments of the present invention propose a group call process between ATs that can efficiently use resources in the specific groups where the call setup is achieved. A description will now be made, in sequence, of a mobile communication system, a call setup method, and a group call method according to exemplary embodiments of the present invention.

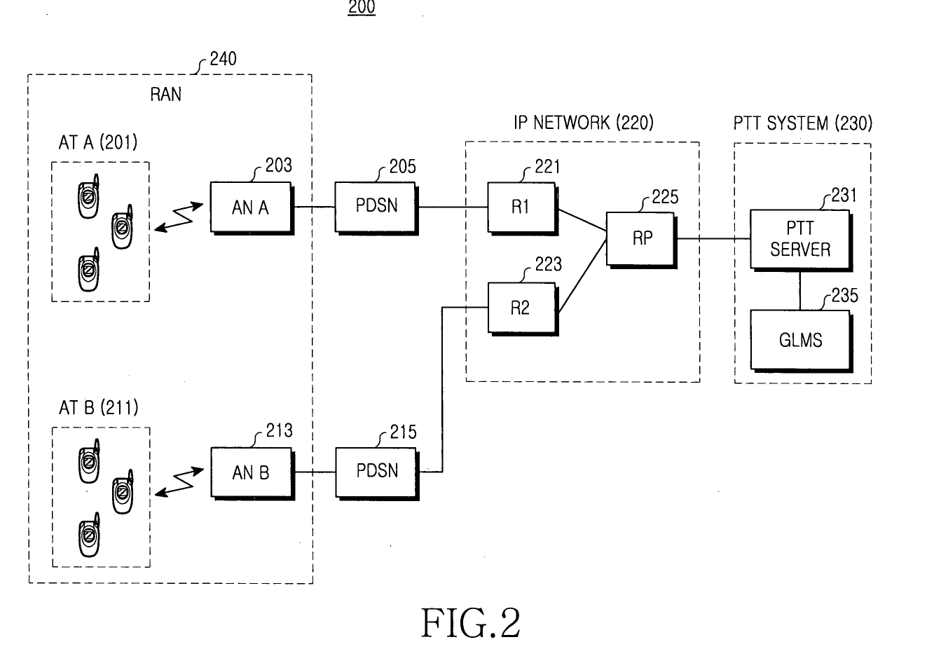

FIG. 2 is a diagram illustrating architecture of a mobile communication system 200 supporting PTT service according to an exemplary embodiment of the present invention. For convenience, it will be assumed herein that a RAN between ATs and Access Networks (ANs) 203 and 213 is a CDMA2000 1x EV-DO network.

Referring to FIG. 2, there is illustrated the architecture of the mobile communication system 200. ATs 201 and 211, terminals capable of receiving both the CDMA2000 1x EV-DO service and the PTT service, provide users the capability of starting a PTT call through a user interface. When the ATs 201 and 211 are powered on or their initial sessions are set up, a group list management server (GLMS) 235 determines whether the ATs 201 and 211 belong to a group and then performs session setup according thereto. That is, if an AT belonging to a group among the ATs 201 and 211 transmits an initial setup request message for performing initial session setup, the GLMS 235 analyzes a received signal and determines whether the AT belongs to the group.

If the AT belongs to the group, the GLMS 235 allocates a multicast IP to the AT. Herein, the multicast IP represents Class D addresses of 224.0.0.1˜238.255.255.254, which are multicast addresses defined in the IP protocol. The group used in the present invention, unlike the conventional group, may refer to an emergency group like the group of policemen or firemen, or the like.

A RAN 240 uses shared channels rather than dedicated channels as radio resources between subscribers in the group in order to support the exemplary multicasting scheme of the present invention.

PDSNs 205 and 215, devices for providing packet data service to the ATs 201 and 211, connect the RAN 240 to an IP network 220.

Routers 221, 223 and 225 of the IP network 220 provide a multicasting function. A routing protocol applied to the present invention recognizes a Class-D multicast IP address, and a Core Based Multicast protocol may be used as the routing protocol. For example, Protocol Independent-Spars Mode (PIM-SM) or Core Based Tree (CBT) protocol can be used for Core Based Multicast. The IP network 220 uses an Internet Group Management Protocol (IGMP) for the messages for setting up a multicast tree. For convenience, it is assumed herein that the PIM-SM protocol is used as a routing protocol. Accordingly, there is provided a Rendezvous Point (RP) router denoted by reference numeral 225. A PTT system 230, a device for providing PTT service to the ATs 201 and 211, includes a PTT server 231 and the GLMS 235. Upon receiving a PTT Floor Request message for call setup from the ATs 201 and 211 in the group, the PTT server 231 sends a Floor Grant message to the ATs 201 and 211 in response thereto. Further, the PTT server 231 manages a PTT group session and distributes voice packet data to called ATs. The PTT server 231 should be aware of an address of the RP router 225 because it performs call set up and data exchange using the multicast IP.

The GLMS 235 sends necessary group information and setup information to the ATs 201 and 211 when the ATs 201 and 211 set up an initial session upon power-on. Further, the GLMS 235 also manages a multicast IP pool and a security session key for the group. That is, when an AT in the group is logged on, the GLMS 235 allocates the multicast IP and the security session key according to a session setup process. Herein, the security session key is used for security between groups, and can be optionally allocated. In the mobile communication system of an exemplary embodiment, if subscribers in the group need to rapidly exchange voice data, they may join in a chat room. The ‘chat room’ refers to a session for enabling a call between subscribers in the group. In the conventional technology, when joining in the chat room, a calling AT should receive a response from other subscribers in the group as to whether they will join in the chat room. However, in an embodiment of the present invention, the calling AT sets up a session for the corresponding chat room by itself without asking the concerned subscribers whether they will join in the chat room. Therefore, the calling AT can achieve fast call setup because there is no need to receive response messages from other ATs in the same group. A description will now be made of an exemplary chat room joining process and a group call transmission method in sequence.

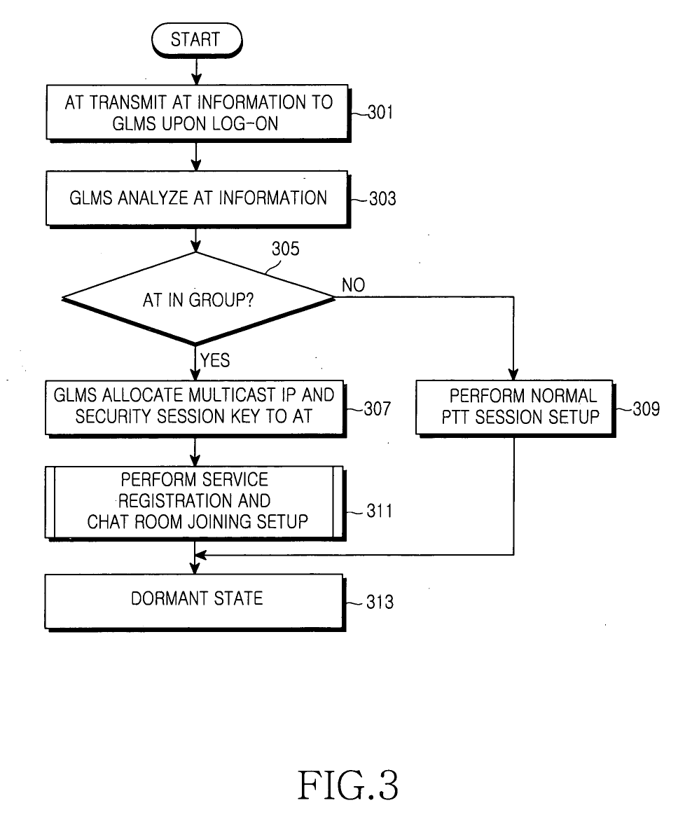

FIG. 3 is a flowchart illustrating a call setup method of an AT in a group in PTT service according to an exemplary embodiment of the present invention.

Referring to FIG. 3, when an AT in a group is powered on or logged on to set up an initial session, the AT transmits its own ID and registration information such as a password to a GLMS 235 in step 301. Upon receiving the registration information, the GLMS 235 analyzes the received registration information in step 303. The GLMS 235 determines in step 305 whether the AT is an AT in the group. If the AT is not an AT in the group, the GLMS 235 performs normal PTT session setup in step 309. The normal PTT session setup is not related to the present invention so a detailed description thereof will be omitted herein.

However, if the AT belongs to the group, the GLMS 235 allocates a multicast IP and a security session key to the AT in step 307. In this case, an RAN 240 allocates radio resources through a shared channel. Herein, the security session key is used for security between groups, and the AT, after being allocated the security session key, encrypts transmission data by applying the key value to a payload of the data before data transmission. Then, the subscribers in the group, receiving the encrypted data, decrypt the received encrypted data using the allocated security session key.

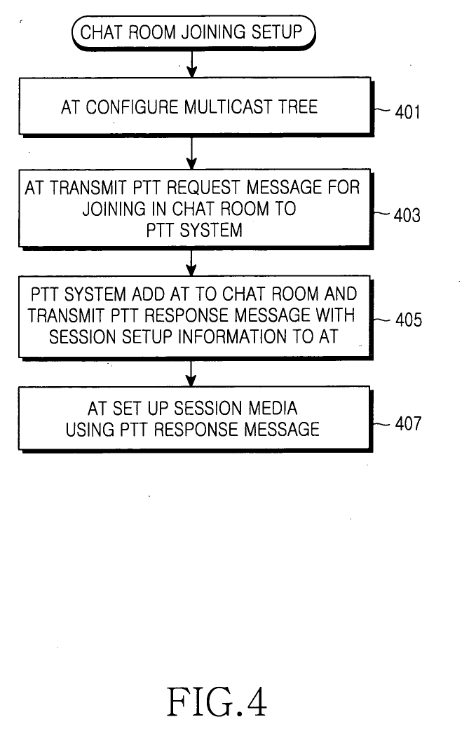

The AT, after it is allocated the multicast IP, performs registration setup for PTT service and automatically performs setup for joining in a chat room for the group in step 311. A detailed description thereof will be given with reference to FIG. 4. After completion of the chat room setup, the GLMS 235 informs the AT of the completion of the session setup. In the session setup completed state, the AT keeps in step 313 a dormant state where no radio resource is activated.

With reference to FIG. 4, a detailed description will now be made of the chat room setup method in step 311.

Referring to FIG. 4, if the AT in the group is allocated the multicast IP in step 307, it configures a multicast tree using a routing protocol in step 401. An exemplary method for configuring a multicast tree using PIM-SM, one of Core Based Multicast schemes, as the routing protocol will be described with reference to the system of FIG. 2. In the following description, the AT in the group will be denoted by reference numeral 201.

If the AT 201, being allocated the multicast IP, transmits an IGMP message via the RAN 204, a PDSN 205 receiving the IGMP message transmits the IGMP message to a first hop router 221. The router 221, upon receiving the IGMP message, transmits a Join message to an RP router 225 that manages the corresponding multicast IP according to the multicast standard, thereby configuring the multicast tree. In this exemplary method, the other ATs in the group also configure the multicast tree.

After configuring the multicast tree, the AT transmits a PTT Request message for joining in a chat room to a PTT system 230 in step 403. Upon receiving the PTT Request message, the PTT system 230 adds the AT to the chat room session and transmits information on the session to the AT using a PTT Response message in step 405. Upon receiving the PTT Response message, the AT sets up session media for the chat room using the received message in step 407.

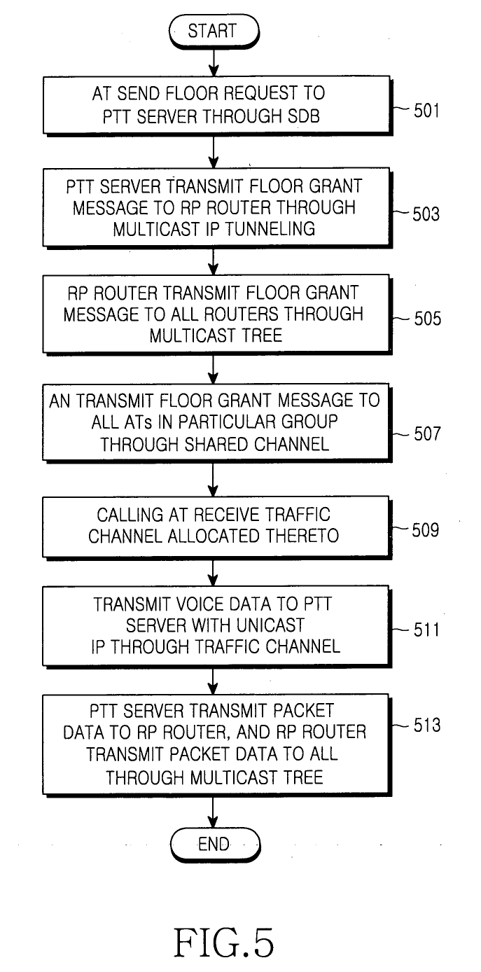

With reference to FIG. 5, a description will now be made of an exemplary process of setting up a group call in the state where ATs in the group are set in the chat room. Herein, the state where ATs in the group are set in the chat room refers to the dormant state where no radio resource is allocated in the state where connection information necessary for network connection is stored in the ATs.

Referring to FIG. 5, in order to transmit voice data to subscribers in a chat room, one of the ATs in the chat room transmits a Floor Request message to a PTT server 231 through a Short Data Burst (SDB) message in the text form in step 501. Upon receiving the Floor Request message, the PTT server 231 transmits a Floor Grant message to an RP router 225 through multicast IP tunneling in step 503. The Floor Grant message is an integrated message of the conventional Floor Grant message and Floor Taken message exchanged between a calling AT and a called AT. Therefore, unnecessary messages can be reduced, contributing to the efficient system management. Further, the “multicast IP tunneling” refers to an exemplary process of encapsulating a multicast packet with a unicast IP packet before transmission.

Upon receiving the Floor Grant message, the RP router 225 transmits the Floor Grant message to all routers 221 and 223 through the multicast tree in step 505. Then a RAN 240 transmits the Floor Grant message to all ATs 201 and 211 in the group through a shared channel in step 507. After receiving the Floor Grant message, the AT 201 that sent the Floor Request message is allocated a traffic channel from an access network (AN) in step 509. Upon receiving the Floor Grant message, the calling AT 201 encrypts voice packet data using an allocated security session key and then transmits the encrypted voice packet data to the PTT server 231 over the allocated traffic channel with the unicast IP in step 511. The PTT server 231 transmits the voice packet data to the RP router 235 in step 513. Then the RP router 235 transmits the voice packet data to all ATs through the multicast tree. In the RAN 240, all ATs in the group receive the voice packet data over the shared channel. Because the voice packet data from the calling AT was encrypted with the security session key allocated to the ATs in the group, only the ATs in the group can decrypt the voice packet data, contributing to an increase in the security.

As can be understood from the foregoing description, the system supporting PTT service according to the exemplary embodiments of the present invention uses the multicasting scheme, and subscribers in a group receive voice packet data over an allocated shared channel in the RAN. Therefore, the system can accommodate many subscribers in the group, and can reduce the processing time. In addition, only the ATs allocated a group session setup key can decrypt the voice packet data from the calling AT, contributing to an increase in the security. Therefore, the PTT service according to the exemplary embodiment of the present invention can be usefully applied to the emergency group of, for example, policemen or firemen, and the like.

While the invention has been shown and described with reference to a certain exemplary embodiments thereof, it will be understood by those skilled in the art that various changes in form and details may be made therein without departing from the spirit and scope of the invention as defined by the appended claims, including the full scope of equivalents thereof.

What is claimed is:

1. A method for setting up a call in a mobile communication system supporting a Push-To-Talk (PTT) service in association with a radio access network (RAN) and an Internet Protocol (IP) network, the method comprising the steps of:
(a) if an access terminal (AT) in a group logs on, performing session setup with a server providing the PTT service using a multicast protocol; and
(b) after the session setup, performing a group call between ATs in the group using a shared channel in the RAN between an access network (AN) and the AT.

2. The method of claim 1, wherein the step (a) comprises the steps of:
if the AT logs on the server, analyzing subscriber information of the AT and transmitting group information and setup information including a multicast IP of the group to the AT; and
receiving, by the AT, the multicast IP allocated thereto, and joining in a chat room for the group.

3. The method of claim 2, wherein the chat room joining step comprises the steps of:
configuring a multicast tree using a multicast routing protocol in the IP network;
transmitting, by the AT, a PTT request message for joining in the chat room to the server;
upon receiving the PTT request message, adding, by the server, the AT to the chat room and transmitting a PTT response message to the AT along with session setup information; and
upon receiving the PTT response message, setting up, by the AT, session media using the PTT response message.

4. The method of claim 3, wherein the multicast routing protocol is a Core Based Multicast protocol.

5. The method of claim 4, wherein the Core Based Multicast protocol is an Internet Group Management Protocol (IGMP).

6. The method of claim 2, further comprising the step of allocating a security session key to the AT to guarantee security of the group.

7. The method of claim 1, wherein the step of performing a group call comprises the steps of:
(b1) if a specific AT in the group obtains a floor, receiving a traffic channel allocated from the access network (AN);
(b2) after obtaining the floor, transmitting data to a rendezvous point (RP) router that manages a multicast routing protocol; and
(b3) transmitting, by the RP router, the received data to all ATs having a multicast IP of the group.

8. The method of claim 7, wherein a floor obtaining step comprises the steps of:
transmitting, by the AT, a floor request message to the server;
transmitting, by the server, a floor grant message to the RP router; and
transmitting, by the RP router, the floor grant message to all ATs having the multicast IP of the group.

9. The method of claim 8, wherein the step (b2) comprises the steps of:
transmitting, by the AT, the data to the RP router;
upon receiving the data, transmitting, by the RP router, the received data to all ATs having the same multicast IP; and
transmitting the data to all ATs in the group over the shared channel.

10. The method of claim 8, wherein the floor request message is transmitted using a short data burst (SDB).

11. A system for providing a Push-To-Talk (PTT) service in association with a Radio Access Network (RAN) and an Internet Protocol (IP) network, comprising:
a plurality of access terminals (ATs) supporting the PTT service, for receiving a multicast IP allocated thereto during session setup, and joining in a chat room for a group for the PTT service using a multicast protocol message;
a plurality of access networks (ANs) for allocating a shared channel to the RAN to process a group call between ATs in the group if the AT is an AT in the group;
a plurality of PTT systems for performing session setup with the AT, allocating information including a multicast IP allocated to the group of the AT during the session setup, and after the session setup, providing the PTT service between the ATs in the group using a routing protocol for the multicast IP in the IP network; and
a plurality of routers for configuring a multicast tree of the group, and upon receiving transmission data from the AT, transmitting the data to the ATs in the group according to the multicast tree.

12. The system of claim 11, wherein the PTT system comprises:
a PTT server for managing a session of the ATs in the group, and upon receiving data transmitted by a calling AT in the group, transmitting the data to the routers to provide a group call between the ATs in the group; and
a group list management server (GLMS) for managing a multicast IP pool and a security session key allocated to the group.

13. The system of claim 11, wherein the routing protocol is a Core Based Multicast protocol.

14. The system of claim 13, wherein the Core Based Multicast protocol is an Internet Group Management Protocol (IGMP).
